(19) United States
(12) Patent Application Publication
(10) Pub. No.: US 2025/0166379 A1
(43) Pub. Date: May 22, 2025

(54) TEXT CONDITIONED VIDEO RESAMPLER FOR VIDEO UNDERSTANDING

(71) Applicant: Google LLC, Mountain View, CA (US)

(72) Inventors: Alessio Tonioni, Zurich (CH); Bruno Korbar, Oxford (GB); Federico Tombari, Zug (CH); Andrew Zisserman, London (GB); Yongqin Xian, Zurich (CH)

(21) Appl. No.: 18/949,777

(22) Filed: Nov. 15, 2024

Related U.S. Application Data
(60) Provisional application No. 63/600,538, filed on Nov. 17, 2023.

(51) Int. Cl. G06V 20/40; G06F 40/35; G06V 10/46

(52) U.S. Cl. CPC G06V 20/46; G06F 40/35; G06V 10/467

(57) ABSTRACT

Methods, systems, and apparatus for video understanding. In one aspect, a conditioned resampler model receives video features of multiple video frames of a video processed by a visual encoder and token embeddings for a specified task. The conditioned resampler model generates conditioned resampler embeddings according to the specified task in response to the video features and token embeddings provided as input. The conditioned resampler embeddings are provided to a large language model as input. The large language model generates, in response to the input conditioned resampler embeddings, a text response to the specified task.

### CROSS-REFERENCE TO RELATED APPLICATIONS

This application claims the benefit under 35 U.S.C. § 119 (e) of U.S. Patent Application No. 63/600,538, filed on Nov. 17, 2023. The disclosure of the foregoing application is incorporated herein by reference in its entirety for all purposes.

### BACKGROUND

This specification relates to model systems, and in particular, visual-language model systems.

Visual-language models (VLMs) have the ability to reason about the relationships of objects in their environment through natural language, often in an interactive fashion. This capability is appealing for multiple video applications. For example, it would be helpful for a model to be able to answer questions about a video: “Does this recipe use eggs?”, “what does he do after he removes the tire?”, etc. It is also appealing for users of augmented reality devices: for example, to have the capability to answer “when did I last see my keys”. Unfortunately, the computational requirements of such models make them impractical for use in video applications as the memory requirement rises quadratically with the input size. Furthermore, a large-enough source of even loosely labelled video data for training such a model from scratch does not readily exist.

### SUMMARY

This specification describes system and methods for a conditioned resampler model and a corresponding pre-training method that works in conjunction with a pre-trained visual encoder and large language model to process long video sequences. The conditioned resampler localizes relevant visual features from the video given a condition and passes them to a pre-trained large langue model which uses the features to generate text. In an implementation, the conditioned resampler resamples visual features from an encoder to determine video features relevant for one or more downstream tasks before passing them to the LLM.

The systems and methods include transformer-based sampling architecture that can process long video features conditioned on the task.

In an implementation, a computer-implemented method comprises receiving, by a conditioned resampler model: video features of multiple video frames of a video processed by a visual encoder, and token embeddings for a specified task; generating, by the conditioned resampler model in response to the video features and token embeddings provided as input, conditioned resampler embeddings according to the specified task; providing the conditioned resampler embeddings to a large language model as input; and generating, by the large language model in response to the conditioned resampler embeddings, a text response to the specified task.

In another aspect, the method further comprises providing as input to the large language model and with the conditioned resampler embeddings, a text prompt; wherein the text response to the specified task generated by the large language model is generated in response to the conditioned resampler embeddings and the text prompt.

In another aspect, the video features include temporal encodings based on the relative times of the video frames in the video.

In another aspect, the token embeddings for the specified task are prefixed with a learnable token specifying a task the conditioned resampler model is to solve and concatenated with a set of learnable query vectors.

In another aspect, the conditioned resampler model: applies self-attention to the token embeddings and learnable query vectors; and applies cross-attention to the token embeddings, learnable query vectors, and the visual features.

In another aspect, applying cross attention precedes applying self-attention.

In another aspect, the conditioned resampler embeddings comprise a fixed length that is independent of the length of the video.

In another aspect, a system comprising one or more computers and one or more storage devices store instructions that are operable, when executed by the one or more computers, to cause the one or more computers to perform the operations of the respective described above.

In another aspect, a computer storage medium is encoded with instructions that, when executed by one or more computers, cause the one or more computers to perform the operations of the method describe above.

In another implementation, a computer-implemented method for training a conditioned resampler model comprises: initializing the conditioned resampler model, comprising: providing first tokens for first source data and second tokens for second source data as input to the conditioned resampler, wherein the first tokens and second tokens are masked so that first tokens self-attend and the second tokens cross-attend to visual features of an untrimmed video sequence and then self-attend, the first source data and second source data being of a same data type; determining an average of the first tokens and second tokens to obtain a data type representation t; and comparing the data type representation t piecewise to the second tokens to determine second source data q with a maximum similarity to t. In another aspect, the initializing the conditioned resampler model further comprises: processing the second tokens and the first tokens by the conditioned resampler without attention masking; applying a binary classifier to each of the learnable query tokens to obtain predictions; and averaging the predictions to obtain an image matching score.

In another aspect, the first tokens comprise text tokens, the first source data comprises text, the second tokens comprise learnable query tokens, the second source data comprises text, the data type comprises text, and the data type representation comprises a text representation.

In another aspect, initializing the conditioned resampler model further comprises: processing the second tokens and the first tokens by the conditioned resampler without attention masking; applying a binary classifier to each of the second tokens to obtain predictions; and averaging the predictions to obtain an image matching score.

In another aspect, the initialization of the conditioned resampler model is performed without using a large language model.

In another aspect, the method further comprises training the conditioned resampler model to attend to one or more specific conditioning tokens, wherein each specific conditioning token corresponds to a specific task, and each specific task is different from each other specific task, wherein the conditioned resampler model generates an input to a large language model; generating, by the large language model in response to the input, a text response to the specific task as an output; applying a generative loss on the output of the large language model; and adjusting parameters of the conditioned resampler model based on the generative loss.

In another aspect, the large language model is not adjusted during the training of the conditioned resampler model.

In another aspect, the specific tasks comprise one or more of: retrieving a time at which a sentence occurs in the untrimmed video sequence; captioning a segment of the untrimmed video sequence; and correcting a corrupted portion of the untrimmed video sequence.

In another aspect, the method further comprises fine tuning the conditioned resampler model on a specific task to be performed by the conditioned resampler.

In another aspect, a system comprising one or more computers and one or more storage devices store instructions that are operable, when executed by the one or more computers, to cause the one or more computers to perform the operations of the training method described above.

In another aspect, a computer storage medium is encoded with instructions that, when executed by one or more computers, cause the one or more computers to perform the operations of the training method describe above.

Some implementations of the subject matter described herein may realize, in certain instances, one or more of the following advantages.

The computational requirements of visual-language models made them impractical for use in video applications as the memory requirement rises quadratically with the input size. Furthermore, sources of labelled video data for training such models from scratch are typically not available. Some visual-language models are not trained from scratch, but rather ‘bridge’ pre-trained models via different types of “visual-to-language adapter modules”. The advantages of this approach, as opposed to training the model from scratch, are numerous: Only a small number of parameters are trained, which makes the memory footprint smaller; it allows for the capabilities of large visual backbones to be utilized without overfitting to the downstream task; as well as to leverage the vast amount of knowledge stored in the language model without suffering common limitations of smaller scale fine-tuning such as catastrophic forgetting. Few such models are trained on videos, and these can usually ingest only a small number of frames-typically anywhere between 4 to 32. Allowing a large number of video frames to interact with text is demonstrably beneficial in visual models, thus, a relatively straightforward way of increasing the model performance is to increase the number of frames the model sees.

The presently described conditioned resampler model provides a model architecture and training method that addresses the challenges mentioned above: due to its lightweight design and use of cross-attention, the presently described conditioned resampler model can process more video frames, e.g., over 100 (and up to 180), at a time, allowing the system to use much larger chunks of video relative to other systems. Further, only a small number of parameters need to be trained, which reduces the memory footprint size during training, resulting in a technical improvement in training resource requirements. This also allows the utilization of large visual backbones without overfitting to a downstream task, while leveraging a vast amount of knowledge built into the large language model without suffering common limitations of smaller-scale fine-tuning such as catastrophic forgetting.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a block diagram of an example conditioned resampler model.

FIG. 2 is a block diagram of an example visual-language model system.

FIG. 3 is a block diagram of an example conditioned resampler model.

FIG. 4 is a flow chart of an example process for performing a specified video

understanding task using a trained conditioned resampler model.

FIG. 5 is a flow chart of an example process for training a conditioned resampler model.

Like reference symbols in the various drawings indicate like elements.

### DETAILED DESCRIPTION

This specification describes a conditioned resampler model that uses a pre-trained and frozen visual encoder and large language model (LLM) to process long video sequences for a task. In some implementations, the conditioned resampler model is a text-conditioned resampler model that is trained, in part, on embeddings from text that defined a task condition. However, the conditioned resampler can be trained on embeddings from other source data, such as an image, video, audio, etc., so long as embeddings defining a conditioned task can be generated from the data. Thus, while the examples in this specification are described with reference to text, the subject matter of this specification are not so limited.

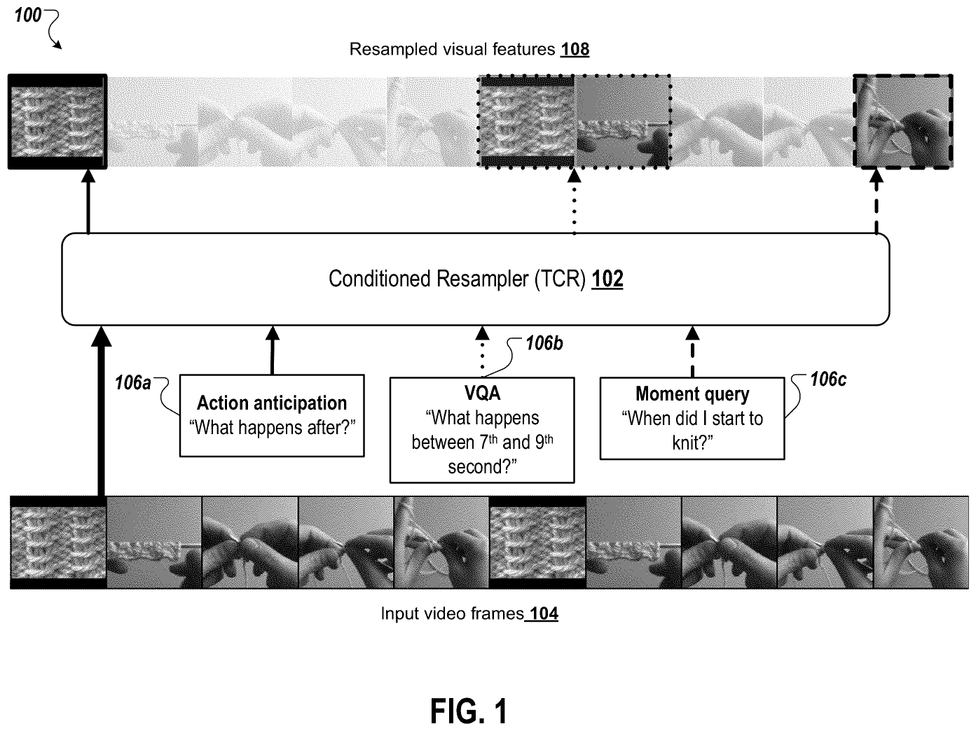

FIG. 1 is a block diagram 100 of an example conditioned resampler model 102. The conditioned resampler model 102 is trained to resample visual features 108 from input video frames 104 that are relevant for a specified task. In this example, where the source data type is text, the resampled visual features 108 have a fixed length that are passed, together with a text prompt, to a language model. The conditioned resampler model 102 resamples the visual features 108 based on source data that specifies the task. In the example described, the source data is conditioning text, e.g., text that species a task. Example tasks include action anticipation 106a, visual question answering 106b, and moment query 106c. Due to its lightweight design and use of cross-attention, the conditioned resampler model 102 can process more than 100 frames at a time with plain attention and without optimized implementations.

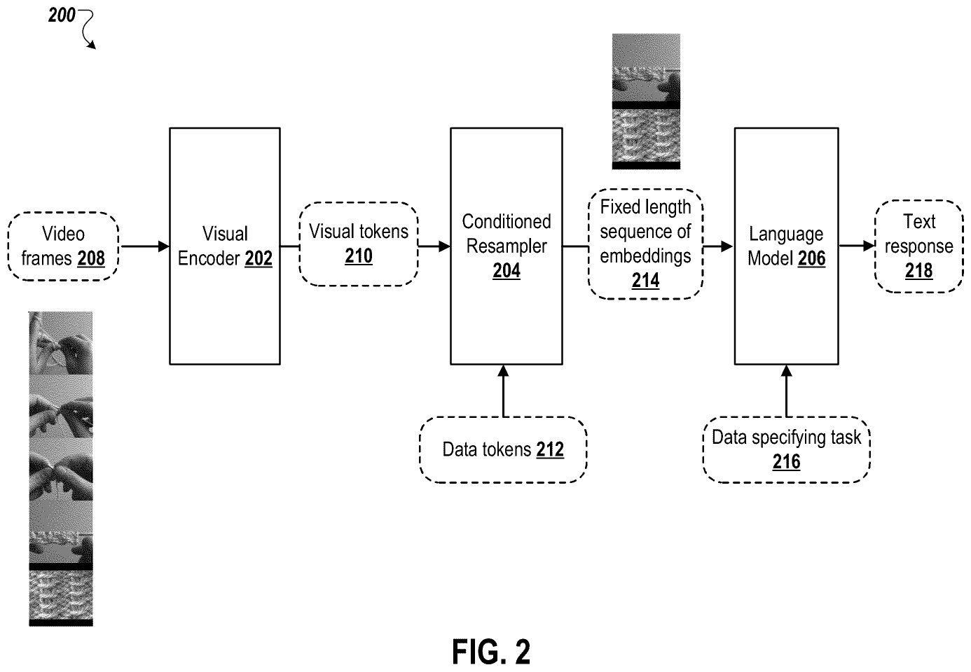

FIG. 2 is a block diagram of an example visual-language model (VLM) system 200 that includes a conditioned resampler model. The example VLM system 200 is an example of a system implemented as computer programs on one or more computers in one or more locations, in which the systems, components, and techniques described herein can be implemented. The example VLM system 200 includes a visual encoder 202, a conditioned resampler model 204, and a language model 206. The components of the example VLM system 200 can be connected via a network, e.g., a local area network (LAN), wide area network (WLAN), the Internet, or a combination thereof, which can be accessed over a wired and/or a wireless communications link.

The visual encoder 202 is a pre-trained (and frozen) visual model that is configured to receive raw video frames 208 as input, e.g., RGB frames of a video. In some implementations the video frames 208 can be preprocessed, e.g., resized or normalized. The visual encoder 202 is configured to process the video frames 208 to extract representative features from the video frames 208, e.g., low-level features such as edges and shapes, higher-level features that encapsulate the semantic content of video frames, or temporal features such as motion dynamics and object interaction across frames. In some implementations the visual encoder 202 can be a vision transformer that uses self-attention mechanisms to process input video frames. The visual encoder 202 is configured to output visual tokens 210 that encode the extracted representative features to the conditioned resampler model 204.

The conditioned resampler model 204 is configured to receive the visual tokens 210 and data tokens 212, e.g., embedded text tokens as input. The embedded text tokens 212 specifies (conditions) a task to be performed by the language model 206 on the video frames 208. The tasks can include captioning, temporal grounding, question-answering, or spatio-temporal grounding. In some implementations, the embedded text tokens 212 can have a [ST] [task prompt] [learnable query] input structure, where [ST] represents a task-specific special token, [task prompt] is, e.g., a question in a question and answer pair, and [learnable queries] are passed to the language model 206. A special task token ([CPN], [TRG], [QA], [STG]) can be prefixed for captioning, temporal grounding, question-answering, and spatio-temporal grounding, respectively, to the task prompt, depending on the task that the model is solving. In some implementations, using tokens in this manner improves overall performance whilst making the model easier to train and reducing the sequence length required for conditioning the sampler (as opposed to spelling out the task in text). In some implementations the embedded text tokens 212 include tokenized timestamps. For example, the embedded text tokens 212 could include a conditioning prompt [CPN] [6] [8] which corresponds to a captioning task to be performed by the language model 206 on the video frames 208, with a corresponding text prompt “what happens in the video between seconds 6 and 8.”

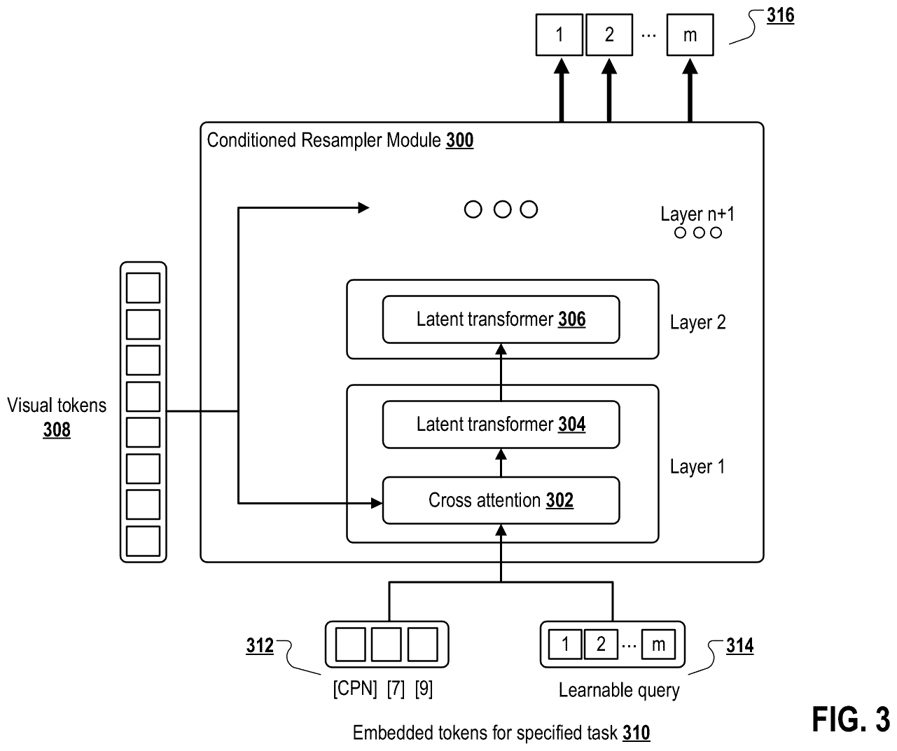

The conditioned resampler model 204 is configured to process both the visual tokens 210 and embedded text tokens 212 to generate a fixed-length sequence of embeddings 214. The conditioned resampler model 204 is configured to select different visual features from the visual tokens 210 according to the task and conditioning prompt included in the embedded text tokens 212 and transform the selected visual features to the fixed-length sequence of embeddings 214 for input to the language model 206. An example conditioned resampler model 204 is described in more detail below with reference to FIG. 3.

The language model 206 is a pre-trained (and frozen) model that is configured to receive the fixed-length sequence of embeddings 214 and a data 216 defining the task as input. In the case of text, the data 216 defining the task is a text prompt. The language model 206 is configured to process the fixed-length sequence of embeddings 214 and a text prompt 216 and generate a text response 218 to the specified task. For example, the text prompt 216 could be the question “what is the cat hearing around its neck” and the text response 218 could be “the cat is wearing a plastic cone”. As another example, the text prompt 216 could be the question “list timestamps when the person is browsing through clothing items on a rack” and the text response 218 could be “1, 7, 8, 9”. As another example, the text prompt 216 could be the question “what is in the video between the 8-th and 10-th second” and the text response 218 could be “A Newfoundland Railway locomotive number 59”. As another example, the text prompt 216 could be the question “what is Cs actions throughout the video, and how does it change, if at all?” and the text response 218 could be “C's goal is to clean the wall”. In some implementations the language model 206 can be a large language model, e.g., a text-to-text transformer model.

FIG. 3 is a block diagram of an example conditioned resampler model 300. Again, in this example, that data defining the task is text, but other data defining the task can be used. The example conditioned resampler model 300 is an example of a system implemented as computer programs on one or more computers in one or more locations, in which the systems, components, and techniques described herein can be implemented. The example system 200 includes a server 202 and a user device 204. The server 202 and user device 204 can be connected via a network, e.g., a local area network (LAN), wide area network (WLAN), the Internet, or a combination thereof, which can be accessed over a wired and/or a wireless communications link.

The conditioned resampler model 300 is a machine learning model that can be configured, through training, to process input visual tokens 308 and embedded text tokens for a specified task 310 and generate corresponding language model inputs 316.

The conditioned resampler model 300 includes multiple layers. The multiple layers include latent transformers (that utilize self-attention) and cross attention mechanisms. For example, in some implementations some of the layers can include a latent transformer and other layers can include both a latent transformer and a cross attention mechanism (also referred to herein as a cross attention layer). In some implementations the cross attention mechanisms can be inserted every other transformer block. For example, in the example shown in FIG. 3, the first layer “layer 1” includes a cross attention mechanism 302 and a latent transformer 304 and the second layer “layer 2” includes a latent transformer 306 (and no cross attention mechanism). Although not shown in FIG. 3, the third layer could then include a cross attention mechanism and a latent transformer and the fourth layer could include a latent transformer, etc. In some implementations the conditioned resampler model 300 can include of 4 transformer blocks with 8 attention heads and hidden dimension equal to 512, where blocks 0 and 2 contain cross-attention layers.

The conditioned resampler model 300 is configured to receive visual tokens 308 as input, e.g., video features of multiple video frames of the video processed by a visual encoder as described above with reference to FIG. 2. The visual tokens 302 are provided as input to each cross attention layer included in the multiple layers. In some implementations the visual tokens 308 can be constructed by extracting visual representations (e.g., 14×14 patches from frames with 2242 resolution) using a visual encoder and adding temporal embeddings. In some implementations, in order to reduce memory consumption, for every other frame a random 50% of its patches can be dropped.

The conditioned resample model 300 also receives first tokens for first source data and second tokens for second source data as input. The first tokens and second tokens are masked so that the first tokens self-attend and the second tokens cross-attend to visual features of an untrimmed video sequence and then self-attend, the first source data and second source data being of a same data type. The average of the average of the first tokens and second tokens to obtain a data type representation t, and the data type representation t is compared piecewise to the second tokens to determine second source data q with a maximum similarity to t.

Here, in this example, the source data is of the text data type. Thus, the conditioned resampler model 300 is also configured to receive embedded text tokens for a specified task 310 as input. The embedded text tokens for the specified task 310 can include conditioning text tokens 312 (that are prefixed with a learnable special token that specifies the task the model is trying to solve), concatenated with a set of learnable query vectors 314, as described above with reference to FIG. 2. The embedded text tokens for the specified task 310 are provided as input to a first cross attention layer in the multiple layers, e.g., cross attention layer 302.

The learnable query vectors 314 and conditioning text tokens 312 interact with each other through the latent transformer layers (which utilize self-attention) and interact with the visual features represented by the visual tokens 308 through the cross-attention layers. As shown, when a layer includes a latent transformer and a cross attention layer, the cross attention precedes the self-attention provided by the latent transformers.

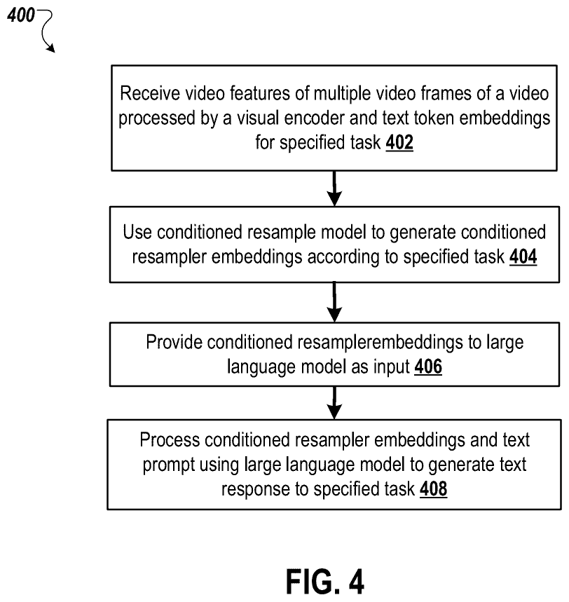

The conditioned resampler model 300 is configured to provide transformed query vectors as output, e.g., to a language model as described above with reference to FIG. 2. The transformed query vectors is a fixed length set, independent of the length of the original video sequence. An example process for performing a specified video understanding task using a trained conditioned resampler model 300 is described in more detail below with reference to FIG. 4.

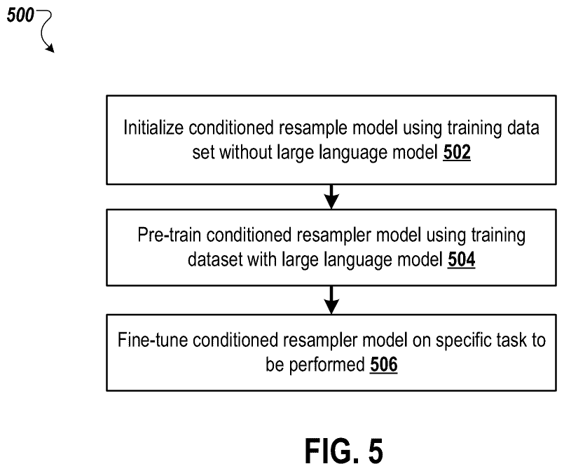

It has been shown that contrastive learning yields visual representations for video frames that perform better in discriminative tasks than training in a purely generative fashion. Training models with a generative loss, however, seems to be important for developing reasoning regarding temporal grounding of unconstrained videos as well as the semantic relationship between text structure and video. Therefore, the conditioned resampler model 300 can be trained using three separate stages: (i) initialization, where we train conditioned resampler without the VLM system language model; (ii) pre-training, where the conditioned resampler model us trained in conjunction with the VLM system language model; and (iii) task-specific fine-tuning. During the training process, the visual encoder and language model included in the VLM system remain frozen throughout. An example process for training a conditioned resampler model is described in more detail below with reference to FIG. 5.

As shown in FIG. 3, the interaction of the query sequence with the visual features is only achieved through cross-attention. This enables the conditioned resampler model 300 to ingest long sequences (as it is not limited by the quadratic complexity of vanilla self-attention). Further, the output of the conditioned resampler model 300 is a fixed length set (the transformed query vectors), so that the input to the language model in the VLM system is only a small number of tokens, irrespective of the length of the video sequence. This significantly reduces the number of input tokens that the language model needs to process with obvious gains in terms of inference time and memory requirements (compared to full self-attention over all frame tokens.)

Further, as shown in FIG. 3, the conditioned resampler model 300 differs from conventional re-samplers in multiple ways. For example, whilst some conventional re-samplers are trained on images, the conditioned resampler model 300 is optimized for video from the ground up-all training stages are done on videos, as described in more detail below with reference to FIG. 5. This enables the conditioned resampler model 300 to learn to sample visual features from video frames conditioned on the task. In addition, the conditioned resampler model 300 uses lower dimensional features compared to conventional re-samplers and an overall smaller number of parameters, e.g., 69M vs 188M. This enables longer video sequences to be processed. Further, the conditioned resampler model 300 cross-attends visual features to text embeddings and learnable queries, whereas conventional re-samplers concatenate visual-embeddings and queries in a key-value pair, which makes the computation more expensive as it computes cross-attention and self-attention in a single pass. The conditioned resampler model separates the operations (i.e. first cross-attending text-query sequence with the video, and then self-attending the text-query sequence). This reduces per-layer computational requirements allowing for the video sequence length to be increased. These differences enable many more frames to be processed at once, which subsequently leads to superior performance on downstream tasks.

FIG. 4 is a flow chart of an example process 400 for performing a specified video understanding task. For convenience, the process 400 will be described as being performed by a system of one or more computers located in one or more locations. For example, a visual-language model system, e.g., the visual-language model system 200 of FIG. 2, appropriately programmed, can perform example process 400.

The system receives video features of multiple video frames of a video processed by a visual encoder and token embeddings for the specified video understanding task (step 402). In implementations where the conditioned resampler model is a text-conditioned resampler (i.e., text is used to specify a task), the token embeddings are text token embeddings. More generally, the token embeddings are embeddings derived from source data specifying the task. The video features can include temporal encodings based on the relative times of the video frames in the video. In some implementations the token embeddings for the specified task can be prefixed with a learnable token specifying a task the conditioned resampler model is to solve and concatenated with a set of learnable query vectors.

In response to the video features and token embeddings being provided as input, the system uses a trained conditioned resampler model to generate conditioned resampler embeddings according to the specified task (step 404). The conditioned resampler embeddings represent resample visual features that are relevant for the specified task. The conditioned resampler model applies self-attention to the token embeddings and learnable query vectors and applies cross-attention to the token embeddings, learnable query vectors, and the visual features. In some implementations, applying cross attention precedes applying self-attention. In some implementations the conditioned resampler embeddings have a fixed length that is independent of the length of the video.

The system provides the conditioned resampler embeddings to a large language model as input (step 406). The system also provides a text prompt as input to the large language model and with the conditioned resampler embeddings. The system processes the conditioned resampler embeddings and text prompt using the large language model to generate a text response to the specified task (step 408). The text response to the specified task generated by the large language model is generated in response to the conditioned resampler embeddings and the text prompt.

FIG. 5 is a flow chart of an example process 500 for training a conditioned resampler model. In some implementations, the conditioned resampler model can be trained on a training dataset that includes videos that are annotated by transcribed speech sentences and their corresponding timestamps (that are either user-generated or automatically generated via automatic-speech recognition). Speech in such videos is rarely visually grounded, however, because the conditioned resampler model can see the video sequence surrounding the annotated segment, it is well suited to implicitly learn the temporal grounding. For convenience, the process 500 will be described as being performed by a system of one or more computers located in one or more locations. For example, a visual-language model system, e.g., the visual-language model system 200 of FIG. 2, appropriately programmed, can perform example process 500.

The system initializes the conditioned resampler model using the training dataset (step 502). The initialization of the conditioned resampler model can be performed without using a large language model. To initialize the conditioned resampler model, the system provides first tokens for first source data and second tokens for second source data as input the conditioned resampler. The first tokens and second tokens can be masked so that the first tokens cross-attend and the second tokens cross-attend to visual features of an untrimmed video sequence and then self-attend. The system then determines an average of the first tokens and second tokens to obtain a first source data representation t and compares the first source data representation t piecewise to the second tokens to determine second source data q with a maximum similarity to t. In some implementations the first tokens are text tokens, the first source data is text, the second tokens are learnable query tokens, the second source data is text, the data type is text, and the data type representation is a text representation.

In some implementations the system processes the second tokens and the first tokens by the conditioned resampler without attention masking, applies a binary classifier to each of the second tokens to obtain predictions, and averages the predictions to obtain an image matching score. For example, the second source data with maximum similarity to t are denoted as q. The representations t and q can then be aligned by contrasting each positive pair with in-batch negative pairs. At this stage, the conditioned resampler model is not text conditioned. Image-text matching objective (video-text matching in our case) primes the model for text-conditioning. Both second source data and first source data can be passed through the conditioned resampler model together, without attention masking. A binary classifier predicting whether the video and first source data are matching or not can be applied to each of the second source data and predictions are averaged to obtain a final matching score. The negatives can be sampled in-batch.

The system pre-trains the conditioned resampler model using the training dataset (step 504). The pre-training of the conditioned resampler model can be performed using a large language model. The objective of pre-training the conditioned resampler model is twofold: first, to semantically and temporally align the conditioned resampler model output with an expected input of the LLM, and second to train the conditioned resampler model's self-attention layer to attend to specific task-specifying special tokens and conditioning tokens. This is achieved as follows. The system trains the conditioned resampler model to attend to one or more specific conditioning tokens, where each specific conditioning token corresponds to a specific task and each specific task is different from each other specific task. In some implementations the specific tasks include one or more of: retrieving a time at which a sentence occurs in the untrimmed video sequence, captioning a segment of the untrimmed video sequence, or correcting a corrupted portion of the untrimmed video sequence. In each case, the TRC model generates an input to a large language model.

The system then processes the inputs using a large language model to generate text responses to the specific task as an output. The system applies a generative loss on the output of the large language model and adjusts parameters of the conditioned resampler model based on the generative loss. In some implementations the large language model is not adjusted during the training of the conditioned resampler model.

The system fine-tunes the conditioned resampler model on a specific task to be performed by the conditioned resampler (step 506). After steps 502 and 504, the conditioned resampler model can achieve competitive results on downstream tasks while still being a generalist model. However, as the training dataset used at steps 502 and 504 may be comprised mostly of low-and mid-quality videos with noisy automatic annotations, significant improvements can be achieved through fine-tuning for a specific task, where the conditioned resampler is aligned with the domain of the downstream task in question. During this step, only the conditioned resampler model and its vocabulary are fine-tuned, whilst the visual encoder and the language model are kept frozen. Fine-tuning can be performed on each of multiple downstream datasets.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, comprising:
receiving, by a conditioned resampler model:
video features of multiple video frames of a video processed by a visual encoder; and
token embeddings for a specified task;
generating, by the conditioned resampler model in response to the video features and token embeddings provided as input, conditioned resampler embeddings according to the specified task;
providing the conditioned resampler embeddings to a large language model as input; and
generating, by the large language model in response to the conditioned resampler embeddings, a text response to the specified task.

2. The computer-implemented method of claim 1, further comprising:
providing as input to the large language model and with the conditioned resampler embeddings, data defining the specified task; and
wherein the text response to the specified task generated by the large language model is generated in response to the conditioned resampler embeddings and the data defining the specified task.

3. The computer-implemented method of claim 2, wherein the data defining the specified task is a text prompt.

4. The computer-implemented method of claim 1, wherein:
the video features include temporal encodings based on the relative times of the video frames in the video.

5. The computer-implemented method of claim 1, wherein:
the token embeddings for the specified task are prefixed with a learnable token specifying a task the conditioned resampler model is to solve and concatenated with a set of learnable query vectors.

6. The computer-implemented method of claim 4, wherein the conditioned resampler model:
applies self-attention to the token embeddings and learnable query vectors; and
applies cross-attention to the token embeddings, learnable query vectors, and the visual features.

7. The computer-implemented method of claim 6, wherein applying cross attention precedes applying self-attention.

8. The computer-implemented method of claim 1, wherein the conditioned resampler embeddings comprise a fixed length that is independent of the length of the video.

9. The computer-implemented method of claim 1, wherein the conditioned resampler model is a text-conditioned resampler model that is trained, in part, on embeddings from text that defined a task condition.

10. A system comprising one or more computers and one or more storage devices storing instructions that are operable, when executed by the one or more computers, to cause the one or more computers to perform operations comprising:
receiving, by a conditioned resampler model:
video features of multiple video frames of a video processed by a visual encoder; and
token embeddings for a specified task;
generating, by the conditioned resampler model in response to the video features and token embeddings provided as input, conditioned resampler embeddings according to the specified task;
providing the conditioned resampler embeddings to a large language model as input; and
generating, by the large language model in response to the conditioned resampler embeddings, a text response to the specified task.

11. A computer storage medium encoded with instructions that, when executed by one or more computers, cause the one or more computers to perform operations comprising:
receiving, by a conditioned resampler model:
video features of multiple video frames of a video processed by a visual encoder; and
token embeddings for a specified task;
generating, by the conditioned resampler model in response to the video features and token embeddings provided as input, conditioned resampler embeddings according to the specified task;
providing the conditioned resampler embeddings to a large language model as input; and
generating, by the large language model in response to the conditioned resampler embeddings, a text response to the specified task.

12. A computer-implemented method for training a conditioned resampler model, comprising:
initializing the conditioned resampler model, comprising:
providing first tokens for first source data and second tokens for second source data as input to the conditioned resampler, wherein the first tokens and second tokens are masked so that the first tokens self-attend and the second tokens cross-attend to visual features of an untrimmed video sequence and then self-attend, the first source data and second source data being of a same data type;
determining an average of the first tokens and second tokens to obtain a data type representation t; and
comparing the data type representation t piecewise to the second tokens to determine second source data q with a maximum similarity to t.

13. The computer-implemented method of claim 12, wherein the first tokens comprise text tokens, the first source data comprises text, the second tokens comprise learnable query tokens, the second source data comprises text, the data type comprises text, and the data type representation comprises a text representation.

14. The computer implemented method of claim 12, wherein the initializing the conditioned resampler model further comprises:
processing the second tokens and the first tokens by the conditioned resampler without attention masking;
applying a binary classifier to each of the second tokens to obtain predictions; and
averaging the predictions to obtain an image matching score.

15. The computer-implemented method of claim 12, wherein the initialization of the conditioned resampler model is performed without using a large language model.

16. The computer-implemented method of clam 12, further comprising:
training the conditioned resampler model to attend to one or more specific conditioning tokens, wherein each specific conditioning token corresponds to a specific task, and each specific task is different from each other specific task, wherein the conditioned resampler model generates an input to a large language model;
generating, by the large language model in response to the input, a text response to the specific task as an output;
applying a generative loss on the output of the large language model; and
adjusting parameters of the conditioned resampler model based on the generative loss.

17. The computer-implemented method of clam 16, wherein the large language model is not adjusted during the training of the conditioned resampler model.

18. The computer-implemented method of claim 16, wherein the specific tasks comprise one or more of:
retrieving a time at which a sentence occurs in the untrimmed video sequence;
captioning a segment of the untrimmed video sequence; or correcting a corrupted portion of the untrimmed video sequence.

19. The computer-implemented method of claim 16, further comprising fine tuning the conditioned resampler model on a specific task to be performed by the conditioned resampler.

20. A system comprising one or more computers and one or more storage devices storing instructions that are operable, when executed by the one or more computers, to cause the one or more computers to perform operations for training a conditioned resampler model, the operations comprising:
initializing the conditioned resampler model, comprising:
providing first tokens for first source data and second tokens for second source data as input to the conditioned resampler, wherein the first tokens and second tokens are masked so that the first tokens self-attend and the second tokens cross-attend to visual features of an untrimmed video sequence and then self-attend, the first source data and second source data being of a same data type;
determining an average of the first tokens and second tokens to obtain a data type representation t; and
comparing the data type representation t piecewise to the second tokens to determine second source data q with a maximum similarity to t.
